(19) United States
(12) Patent Application Publication
(10) Pub. No.: US 2025/0328721 A1
(43) Pub. Date: Oct. 23, 2025

(54) DOCUMENT FILE MANAGEMENT APPARATUS, METHOD, AND STORAGE MEDIUM

(71) Applicant: Toshiba Tec Kabushiki Kaisha, Tokyo (JP)

(72) Inventor: Takahiro OGISU, Mishima Shizuoka (JP)

(21) Appl. No.: 19/061,861

(22) Filed: Feb. 24, 2025

(30) Foreign Application Priority Data
Apr. 22, 2024 (JP) 2024-069337

(51) Int. Cl. G06F 40/166; G06F 16/93; G06F 40/103

(52) U.S. Cl. CPC G06F 40/166; G06F 16/93; G06F 40/103

(57) ABSTRACT

A document file management apparatus includes a communication interface, a storage device that stores reference data containing language rules associated with user attributes, and a processor configured to control the communication interface to receive, from a terminal device, a document file including text data and a user attribute of a user of the terminal device, read a language rule corresponding to the received user attribute from the reference data, generate a query including an instruction to correct text included in the text data based on the read language rule, input the text data and the generated query to a computer model, which generates in response thereto corrected text according to the instruction in the query, and output and store the corrected text in the storage device as a new document file.

### CROSS-REFERENCE TO RELATED APPLICATION

This application is based upon and claims the benefit of priority from Japanese Patent Application No. 2024-069337, filed Apr. 22, 2024, the entire contents of which are incorporated herein by reference.

### FIELD

Embodiments described herein relate generally to a document file management apparatus, a method, and a storage medium.

### BACKGROUND

Conventionally, paper documents, on which text is printed or handwritten, are converted into image data using a scanner, a camera, or the like to go paperless. Also, there is a text recognition technology called Optical Character Recognition/Reader (OCR) for recognizing text in image data to convert the image data into text data.

In OCR, when text is erroneously recognized, image data is converted into erroneous text data that needs to be checked and corrected by a human. Therefore, a technology for correcting text data using an AI model has been proposed.

Meanwhile, documents handled by a user in an office or the like often use expressions including terms specific to an organization or a department to which the user belongs. However, in the above-described related-art technology, attributes of the user, such as an organization and a department to which the user performing OCR belongs, are not taken into account in correcting text data. Therefore, with the related-art technology, although errors can be corrected, it is not possible to correct text data considering the attributes of the user. Accordingly, there is a room for improvement in terms of convenience.

### SUMMARY OF THE INVENTION

Embodiments of the present invention provide an information processing apparatus, a method, and a storage medium capable of correcting text according to user attributes.

According to an aspect of the present disclosure, a document file management apparatus includes a communication interface, a storage device that stores reference data containing language rules associated with user attributes, and a processor configured to: control the communication interface to receive, from a terminal device, a document file including text data and a user attribute of a user of the terminal device, read a language rule corresponding to the received user attribute from the reference data, generate a query including an instruction to correct text included in the text data based on the read language rule, input the text data and the generated query to a computer model, which generates in response thereto corrected text according to the instruction in the query, and output and store the corrected text in the storage device as a new document file.

### BRIEF DESCRIPTION OF THE DRAWINGS

FIG. 1 is a diagram illustrating a schematic configuration of an information processing system according to an embodiment.

FIG. 2 is a block diagram illustrating a hardware configuration of an edge device according to the embodiment.

FIG. 3 is a block diagram illustrating a hardware configuration of an edge server according to the embodiment.

FIG. 4 is a table showing a data configuration of a reference DB according to the embodiment.

FIG. 5 is a block diagram illustrating a functional configuration of the edge device.

FIG. 6 is a block diagram illustrating a functional configuration of the edge server.

FIG. 7 is a sequence diagram illustrating an example of a control process performed by the information processing system.

### DETAILED DESCRIPTION

Hereinafter, embodiments of the present disclosure are described with reference to the drawings. In the embodiments described below, an edge server 2 installed in an office or the like is described as an example of an information processing apparatus. However, the present disclosure is not limited to the embodiments described below.

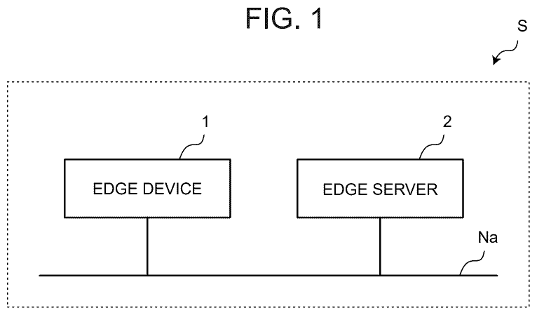

FIG. 1 is a diagram illustrating a schematic configuration of an information processing system S according to an embodiment. As illustrated in FIG. 1, the information processing system S includes an edge device 1 and an edge server 2.

The edge device 1 and the edge server 2 are connected to each other for communication via a network Na, such as a Local Area Network (LAN). Note that two or more edge devices 1 may be connected to the edge server 2.

The edge device 1 is a terminal device used by a user of the information processing system S. The edge device 1 may be any type of device, or a system including the device, that serves as an interface between the information processing system S and the user. For example, the edge device 1 is a scanner device of an image forming apparatus, such as a facsimile apparatus, or a multifunction peripheral (MFP).

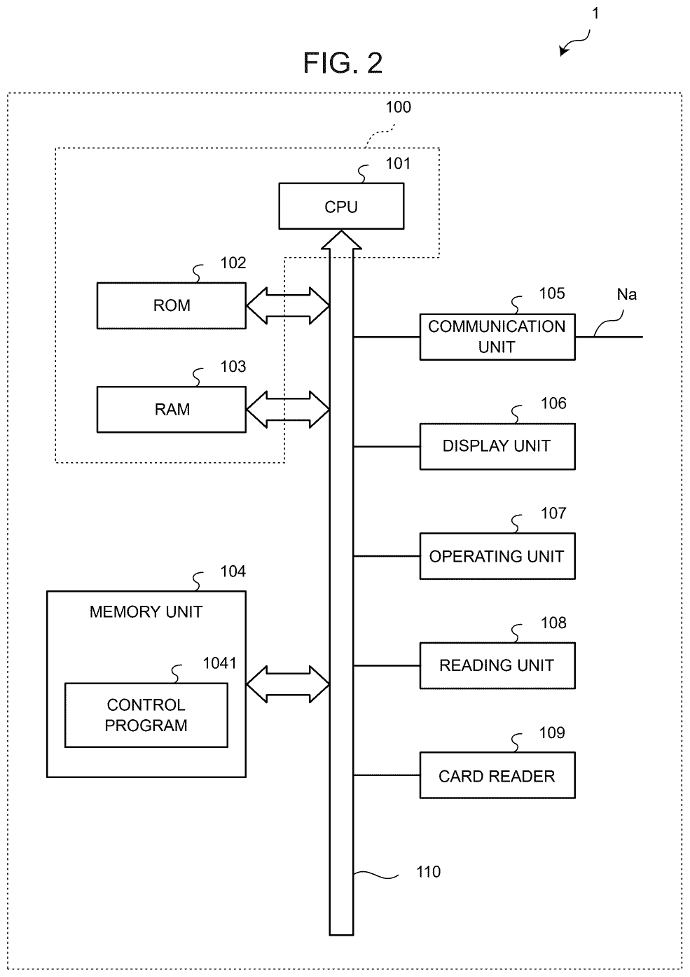

The edge device 1 exchanges various kinds of information with the edge server 2. Specifically, the edge device 1 uses a card reader 109 (see FIG. 2), which will be described later, to obtain a user attribute of a user, who operates the edge device 1, from a medium, such as an employee ID card, storing information for identifying an individual. Here, the user attribute is identification information for identifying, for example, an organization, a department, or the like to which the user operating the edge device 1 belongs. Note that the user attribute is not limited to this example. As another example, the user attribute may be the job title or the position of the user operating the edge device 1. Also, for example, the user attribute may be a user ID of the user.

When receiving an instruction to perform a reading process from the user via an operating unit 107 (see FIG. 2), which will be described later, the edge device 1 reads a document on a paper medium or the like, and acquires an image of the document. Then, the edge device 1 performs a text recognition process (hereinafter, also referred to as an OCR process) on the acquired image and extracts text included in the image as text data (hereinafter, also simply referred to as text). Any known technology may be used for the OCR process.

Note that the image to be the target of the OCR process is not limited to the image acquired by the reading process. For example, the edge device 1 may perform an OCR process on an image stored in itself or an image acquired from an external server connected via a network (not shown) for communication.

Also, based on the text extracted by the OCR process, the edge device 1 generates a document file with a general-purpose file format. For example, the edge device 1 generates a file (hereinafter, also referred to as a PDF file) in the Portable Document Format (PDF) based on the text extracted by the OCR process. Then, the edge device 1 transmits the user attribute and the PDF file to the edge server 2. It is preferable that the PDF file is generated in a format in which the text included in the PDF file is searchable, that is, the text is extractable from the PDF file.

Furthermore, upon receiving a storage completion notification from the edge server 2, the edge device 1 displays, on a display unit 106 (see FIG. 2) described later, a message informing the user of the edge device 1 that the storage of the PDF file has been completed. Details of the storage completion notification will be described later.

The edge server 2 is installed in, for example, an office and performs document management. The edge server 2 corrects the text extracted by the OCR process according to the user attribute. Also, the edge server 2 changes the storage destination (or output destination) of the corrected text in accordance with the user attribute.

Next, a hardware configuration of the edge device 1 will be described. FIG. 2 is a block diagram illustrating a hardware configuration of the edge device 1 according to the present embodiment.

As illustrated in FIG. 2, the edge device 1 includes a Central Processing Unit (CPU) 101, a Read-Only Memory (ROM) 102, a Random Access Memory (RAM) 103, and a memory unit 104.

The CPU 101 controls other components of the edge device 1. The ROM 102 stores various programs. The RAM 103 is a workspace into which programs and various types of data are loaded.

The memory unit 104 is a non-volatile memory, such as a Hard Disk Drive (HDD) or a flash memory, that retains stored data even when the power is turned off. The memory unit 104 stores a control program 1041.

The control program 1041 is for controlling the edge device 1. The CPU 101, the ROM 102, the RAM 103, and the memory unit 104 are connected to each other via a bus 110. The CPU 101, the ROM 102, and the RAM 103 constitute a control unit 100 with a computer configuration. That is, the CPU 101 of the control unit 100 executes a control process, which will be described later, to control the edge device 1 in accordance with the control program 1041 that is stored in the ROM 102 or the memory unit 104 and loaded into the RAM 103.

The control unit 100 is connected to a communication unit 105, a display unit 106, an operating unit 107, a reading unit 108, and a card reader 109 via the bus 110.

The communication unit 105 is a communication interface, such as a LAN interface (I/F), and is connected to the network Na. The communication unit 105 transmits and receives various types of data to and from, for example, the edge server 2 via the network Na.

The display unit 106 is a display device, such as a Liquid Crystal Display (LCD). The display unit 106 displays various types of data under the control of the CPU 101. The operating unit 107 is an input device, such as a keyboard or a pointing device. The operating unit 107 receives operations and transmits information indicating the operations to the CPU 101. The operating unit 107 may also be a touch panel provided on the display unit 106.

The reading unit 108 is a scanner device using a CCD (Charge Coupled Device) sensor, a Contact Image Sensor (CIS), or the like. The reading unit 108 reads a document placed on a scanner bed (not shown) of the edge device 1.

The card reader 109 is, for example, a magnetic card reader that reads information from a card medium, such as a magnetic card. The card reader 109 reads a user attribute from the card medium. The card reader 109 may be configured to read information from any other type of card medium, such as an IC card, in addition to or instead of a magnetic card.

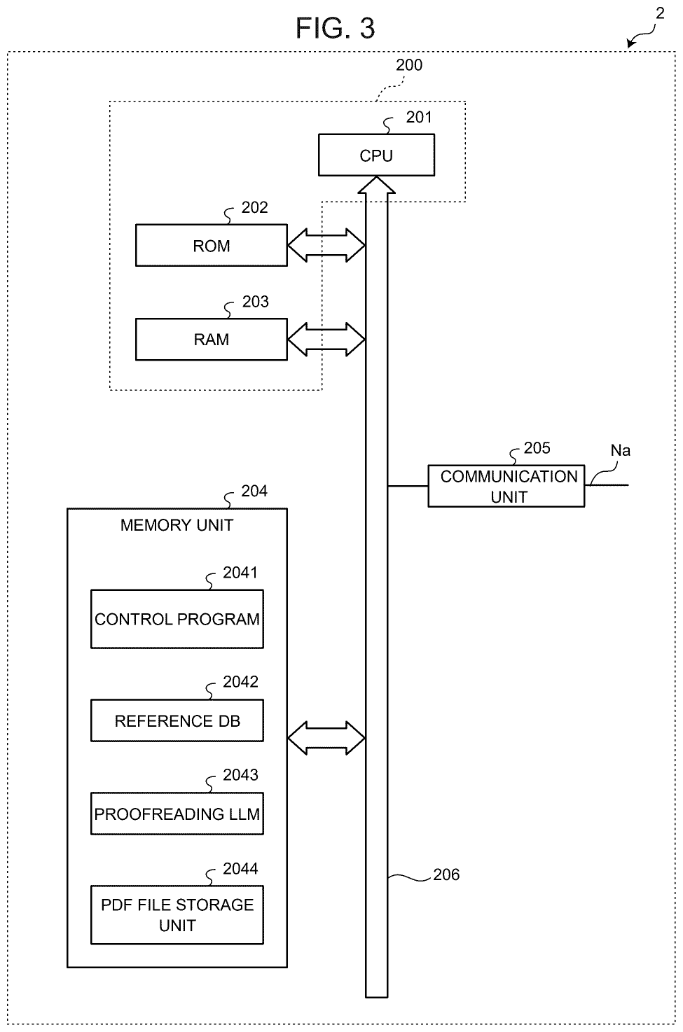

Next, a hardware configuration of the edge server 2 will be described. FIG. 3 is a block diagram illustrating a hardware configuration of the edge server 2 according to the present embodiment.

As illustrated in FIG. 3, the edge server 2 includes a CPU 201, which is an example of a processor, a ROM 202, a RAM 203, and a memory unit 204.

The CPU 201 controls other components of the edge server 2. The ROM 202 stores various programs. The RAM 203 is a workspace into which programs and various types of data are loaded.

The memory unit 204 is a non-volatile memory, such as an HDD or a flash memory, that retains stored data even when the power is turned off. The memory unit 204 is an example of a storage device. The memory unit 204 stores a control program 2041, a reference database DB 2042, a proofreading LLM 2043, and a PDF file storage unit 2044.

The control program 2041 is for controlling the edge server 2. The CPU 201, the ROM 202, the RAM 203, and the memory unit 204 are connected to each other via a bus 206. The CPU 201, the ROM 202, and the RAM 203 constitute a control unit 200 with a computer configuration. That is, the CPU 201 of the control unit 200 executes a control process, which will be described later, to control the edge server 2 in accordance with the control program 2041 that is stored in the ROM 202 or the memory unit 204 and loaded into the RAM 203.

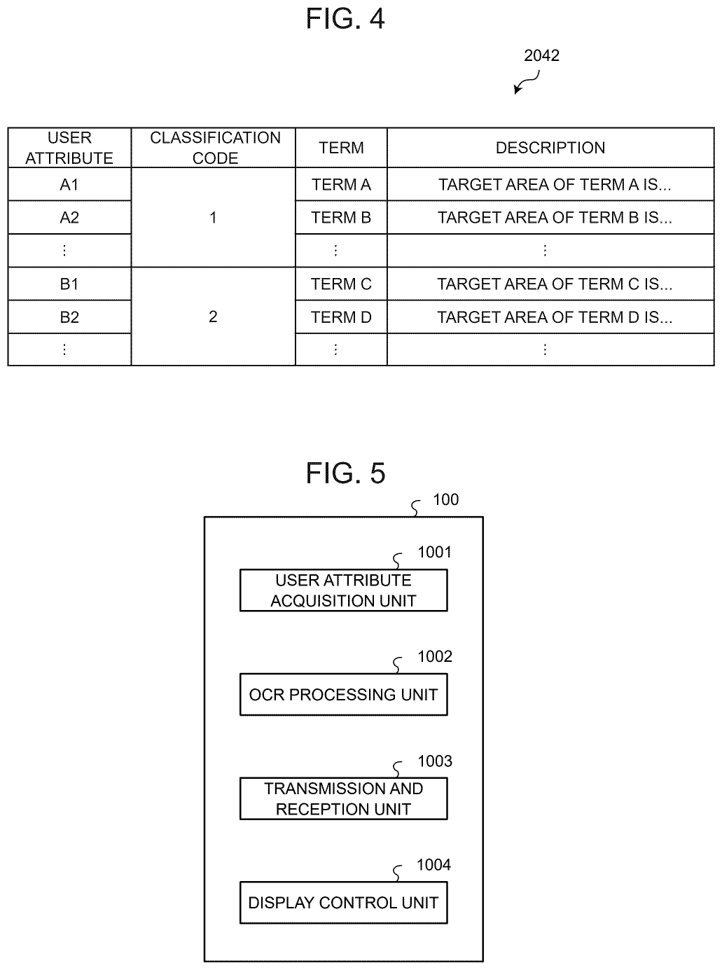

The reference DB 2042 is a data table or a database for managing information related to an organization to which the user operating the edge device 1 belongs. FIG. 4 is a table showing an example of a data configuration of the reference DB 2042. As shown in FIG. 4, the reference DB 2042 stores user attributes, classification codes, and multiple sets of DB information including terms and descriptions in association with each other. Each classification code is associated with one or more user attributes and one or more sets of DB information. Here, combinations of user attributes, classification codes, and multiple sets of DB information correspond to reference data.

The classification code is an example of identification information associated with one or more user attributes. For example, when a user attribute “A1” shown in FIG. 4 is identification information for an accounting department, because the user attribute “A1” is associated with a classification code “1”, the user attribute “A1”, that is, the accounting department, is associated with sets of DB information with the classification code “1”. Similarly, when a user attribute “B1” is identification information for a technical department, because the user attribute “B1” is associated with a classification code “2”, the user attribute “B1”, that is, the technical department, is associated with sets of DB information with the classification code “2”. Here, the classification code may also be referred to as identification information for classifying user attributes of users who use common language rules for documents.

Each term represents, for example, a keyword or terminology that is used in common within a group to which the user operating the edge device 1 belongs. Each description is, for example, text describing the usage of the corresponding term. For example, the description corresponding to the term “POS” is “the abbreviation of Point of Sale and a term related to the management of information at the time when an item of a store is sold”.

Here, the terms and descriptions are examples of language rules in the present embodiment. Language rules define the rules of language used in documents handled by each of organizations classified by user attributes and classification codes. The terms and descriptions are used, for example, to replace synonyms.

Note that the terms and the descriptions are not necessarily expressed in a natural language, but may instead be expressed in semantic vectors calculated by a known natural language processing technique or the like. Also, the terms and the descriptions may be expressed in both of a natural language and semantic vectors. In addition, keywords registered as “terms” are preferably characteristic terms (for example, jargons) used in the group to which the user belongs.

Returning to FIG. 3, the proofreading LLM 2043 is a generative artificial intelligence (AI), such as a Large Language Model (LLM), for generating text and is installed in the edge server 2 (or the memory unit 204). The proofreading LLM 2043 corrects text according to the user attribute and generates corrected text. Here, the corrected text is obtained by correcting errors, such as misspellings and missing characters, in the text extracted by the OCR process. Misspellings and missing characters may be present in the original text and may also be caused by erroneous reading (erroneous recognition) in the OCR process. Note that, although LLM is used as a generative AI in the present embodiment, any other AI model capable of generating text may also be used.

The proofreading LLM 2043 is constructed by a known deep learning technique or the like and is configured to receive text together with a condition and to output text corrected based on the condition. Here, the condition is, for example, a reference condition for deriving an output result or a constraint condition for narrowing down output results.

The proofreading LLM 2043 of the present embodiment generates corrected text corresponding to the user attribute of the user operating the edge device 1 in response to a query (hereinafter, also referred to as a prompt) generated based on DB information extracted from the reference DB 2042 and an instruction instructing the correction of the text.

The PDF file storage unit 2044 is an example of a file storage area. The PDF file storage unit 2044 stores PDF files. The PDF file storage unit 2044 is preferably divided into multiple storage areas corresponding to user attributes. The PDF file storage unit 2044 stores, according to user attributes, PDF files in which text extracted by the OCR process has been updated to corrected text generated by the proofreading LLM 2043.

The control unit 200 is connected to a communication unit 205 via the bus 206. The communication unit 205 is a communication interface, such as a LAN I/F, and is connected to the network Na. The communication unit 205 transmits and receives various types of data to and from the edge device 1 via the networked Na.

Next, a functional configuration of the edge device 1 will be described. FIG. 5 is a block diagram illustrating an example of a functional configuration of the edge device 1. As illustrated in FIG. 5, the control unit 100 includes a user attribute acquisition unit 1001, an OCR processing unit 1002, a transmission and reception unit 1003, and a display control unit 1004 as functional components. Note that the functional configuration of the edge device 1 is not limited to this example.

The control unit 100 (or the CPU 101) of the edge device 1 implements the above-described functional configuration by executing the control program 1041 stored in the memory unit 104. In the present embodiment, the above-described functional configuration is a software configuration implemented by the cooperation between the processor and the program of the edge device 1. However, the present disclosure is not limited to this example, and a part or the entirety of the functional configuration of the edge device 1 may be implemented by hardware components, such as dedicated circuits.

The user attribute acquisition unit 1001 acquires a user attribute. Specifically, the user attribute acquisition unit 1001 acquires the user attribute of the user who operates the edge device 1 by cooperating with the card reader 109 of the edge device 1.

The OCR processing unit 1002 performs an OCR process on an image acquired by the edge device 1 to extract text from the image. Specifically, the OCR processing unit 1002 receives an instruction to execute an OCR process from the user operating the edge device 1 via the operating unit 107 and acquires an image of a document using the reading unit 108. Then, the OCR processing unit 1002 executes an OCR process on the acquired image to extract text (hereinafter, also referred to as extracted text) from the image. The OCR processing unit 1002 generates a document file with a general-purpose file format based on the extracted text. In the present embodiment, it is assumed that the OCR processing unit 1002 generates a PDF file.

The transmission and reception unit 1003 transmits and receives various kinds of information to and from the edge server 2. Specifically, the transmission and reception unit 1003 transmits the user attribute acquired by the user attribute acquisition unit 1001 and the PDF file generated by the OCR processing unit 1002 to the edge server 2. When receiving a storage completion notification from the edge server 2, the transmission and reception unit 1003 instructs the display control unit 1004 to cause the display unit 106 of the edge device 1 to display a PDF storage completion message.

The display control unit 1004 causes the display unit 106 to display various screens in cooperation with other functional components. Specifically, the display control unit 1004 receives an instruction from the transmission and reception unit 1003 and causes the display unit 106 of the edge device 1 to display a message indicating the completion of storage of the PDF file.

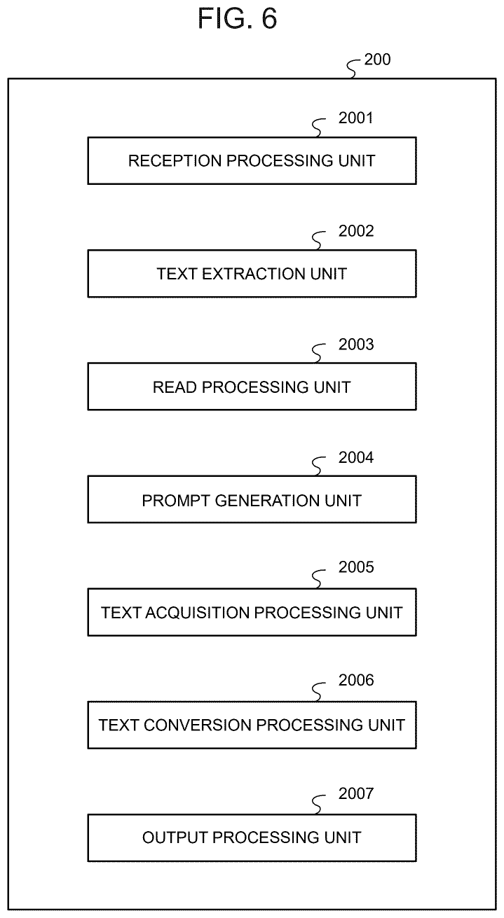

Next, a functional configuration of the edge server 2 will be described. FIG. 6 is a block diagram illustrating an example of a functional configuration of the edge server 2. As illustrated in FIG. 6, the control unit 200 includes a reception processing unit 2001, a text extraction unit 2002, a read processing unit 2003, a prompt generation unit 2004, a text acquisition processing unit 2005, a text conversion processing unit 2006, and an output processing unit 2007 as functional components. The functional configuration of the edge server 2 is not limited to this example.

The control unit 200 (the CPU 201 or the processor) of the edge server 2 implements the above-described functional configuration by executing the control program 2041 stored in the memory unit 204. In the present embodiment, the above-described functional configuration is a software configuration implemented by the cooperation between the processor and the program of the edge server 2. However, the present invention is not limited to this example, and a part or the entirety of the functional configuration may be implemented by hardware components, such as dedicated circuits.

The reception processing unit 2001 is an example of a first acquisition unit. The reception processing unit 2001 acquires, from the edge device 1, text data and the user attribute of a user who uses the text data. Specifically, the reception processing unit 2001 receives (or acquires) a PDF file and a user attribute transmitted by the edge device 1.

The text extraction unit 2002 extracts text from a document file with a general-purpose file format. Specifically, when the reception processing unit 2001 receives (or acquires) a PDF file and a user attribute, the text extraction unit 2002 extracts text from the PDF file. The text extracted from the PDF file is referred to as extracted text.

The read processing unit 2003 is an example of a reading unit. The read processing unit 2003 reads, from the reference DB 2042, language rules corresponding to the user attribute acquired by the reception processing unit 2001. Specifically, the read processing unit 2003 refers to the reference DB 2042 of the edge server 2 to identify a classification code corresponding to the user attribute received (or acquired) by the reception processing unit 2001. Next, the read processing unit 2003 reads, from the reference DB 2042, DB information that corresponds to the identified classification code and has a similarity level greater than or equal to a predetermined threshold with respect to a term included in the extracted text or the usage of the term.

Here, each language rule defines a term and the usage of the term. The DB information in the reference DB 2042 is an example of the language rule. Note that any known technique, such as natural language processing or morphological analysis, may be used to extract an element corresponding to a language rule from a sentence.

The similarity level may be calculated based on a word-level concordance rate between the extracted text extracted by the text extraction unit 2002 and the DB information corresponding to the classification code identified by the read processing unit 2003. Also, for example, the similarity level may be calculated by semantically vectorizing text extracted by the text extraction unit 2002 by a known natural language processing technique or the like and calculating a cosine similarity between the semantically vectorized text and semantically vectorized DB information.

For example, assuming that the reference DB 2042 has a data configuration as shown in FIG. 4, when the user attribute is “A1” and “term A” is included in the extracted text, the read processing unit 2003 refers to the reference DB 2042 and determines the classification code “1” corresponding to the user attribute “A1”. Next, since “term A” included in the extracted text is included in the DB information corresponding to the classification code “1” (that is, the similarity level is greater than or equal to the predetermined threshold), the read processing unit 2003 reads the DB information corresponding to “term A” from the reference DB 2042, that is, “term A” and the description “target area of term A is . . . ”.

Also, for example, assuming that the reference DB 2042 has a data configuration as shown in FIG. 4, when the user attribute is “A1” and “term C” is included in the extracted text, the read processing unit 2003 refers to the reference DB 2042 and determines the classification code “1” corresponding to the user attribute “A1”. In this case, since “term C” included in the extracted text is not included in the DB information corresponding to the classification code “1” (that is, the similarity level is not greater than or equal to the predetermined threshold), the read processing unit 2003 does not read DB information regarding “term C” from the reference DB 2042.

When a term included in the extracted text is not included in the DB information corresponding to the classification code, the read processing unit 2003 may refer to the DB information corresponding to other classification codes and determine whether the term included in the extracted text exists. For example, when the user attribute is “A1” and the extracted text includes “term C” that does not exist in the DB information corresponding to the classification code “1”, the read processing unit 2003 refers to the DB information corresponding to the classification code “2” and determines whether “term C” exists. In the reference DB 2042 illustrated in FIG. 4, since “term C” exists in the DB information corresponding to the classification code “2”, the read processing unit 2003 reads the description of “term C” and searches the DB information corresponding to the classification code “1” for a description similar to the read description. When a description with a similarity level greater than or equal to a threshold exists in the DB information corresponding to the classification code “1”, the read processing unit 2003 reads the corresponding DB information as the DB information for “term C”. For example, when the similarity level between the description of “term C” and the description of “term B” is greater than or equal to the threshold, in other words, when “term B” is a synonym of “term C”, the read processing unit 2003 reads the DB information of “term B” for “term C”.

Also, when a term included in the extracted text is not included in the DB information corresponding to the classification code, the read processing unit 2003 may identify the usage of the term included in the extracted text by referring to dictionary data (not shown) that stores the usages of terms. In this case, the read processing unit 2003 may search the DB information corresponding to the user attribute based on the identified usage to find the DB information of a synonym of the term included in the extracted text and read the found DB information as the DB information corresponding to the term included in the extracted text. The dictionary data may be stored in the memory unit 204 or may be stored in an external device.

The prompt generation unit 2004 is an example of a generation unit. The prompt generation unit 2004 generates a prompt (or a query) including an instruction instructing the correction of extracted text based on a language rule read by the reading processing unit 2003. Specifically, the prompt generation unit 2004 generates a prompt including an instruction instructing the correction of extracted text based on DB information that is read from the reference DB 2042 by the reading processing unit 2003 based on a user attribute received (or acquired) by the reception processing unit 2001.

Here, the prompt may be selected from multiple types of templates based on a user attribute or the like. Also, the prompt preferably includes the details of an instruction, such as “correct only misspellings and missing characters” or “replace terms based on DB information read from the reference DB 2042”.

The text acquisition processing unit 2005 is an example of a second acquisition unit. The text acquisition processing unit 2005 inputs extracted text and a prompt generated by the prompt generation unit 2004 to the proofreading LLM 2043, which corrects the extracted text according to the instruction in the prompt to generate corrected text, and acquires the corrected text generated by the proofreading LLM 2043.

The text conversion processing unit 2006 is an example of a conversion unit. The text conversion processing unit 2006 converts the corrected text into a general-purpose file format. Specifically, the text conversion processing unit 2006 converts the corrected text acquired by the text acquisition processing unit 2005 into a PDF file.

The output processing unit 2007 determines an output destination according to the user attribute and outputs (or stores) the PDF file to the determined output destination. Here, the output destination may be set freely. For example, the output-processing unit 2007 stores the PDF file in the PDF file storage unit 2044. Also, for example, the output processing unit 2007 transmits a storage completion notification to the edge device 1.

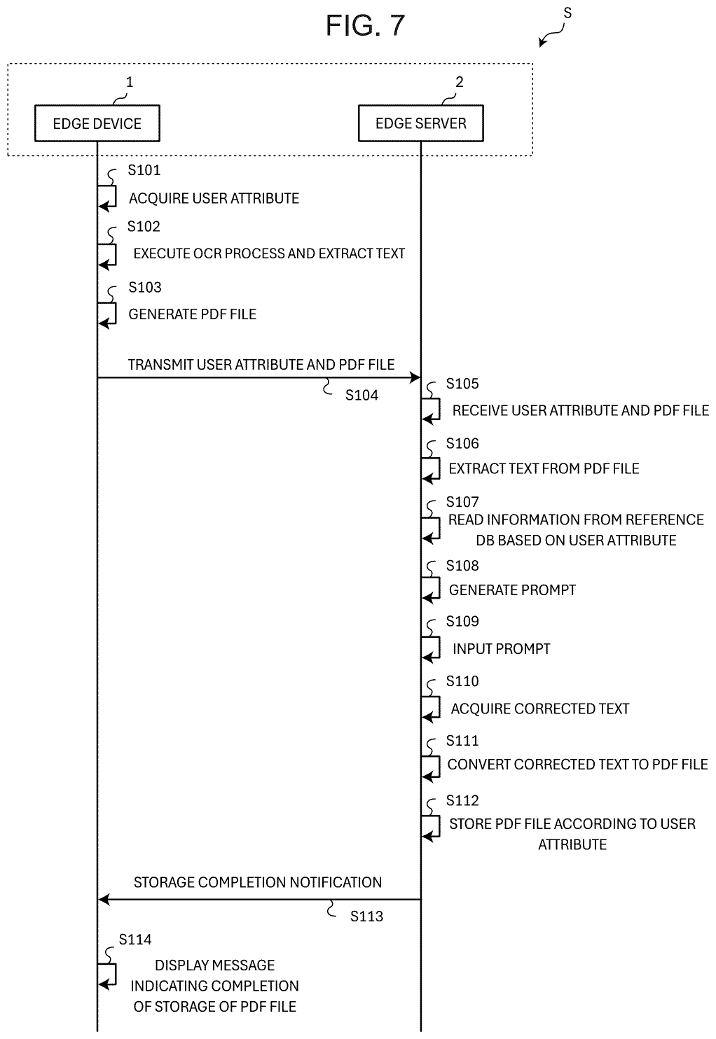

Next, a control process performed by the information processing system S will be described. FIG. 7 is a sequence diagram illustrating an example of a control process performed by the information processing system S according to the present embodiment. In the sequence diagram illustrated in FIG. 7, the edge device 1 transmits a user attribute and a PDF file to the edge server 2. Then, the edge server 2 generates a prompt including an instruction instructing the correction of extracted text based on DB information that corresponds to the user attribute and read from the reference DB 2042. The edge server 2 then inputs the prompt to the proofreading LLM 2043 and acquires corrected text generated by the proofreading LLM 2043. Then, the edge server 2 outputs the acquired corrected text to an output destination corresponding to the user attribute. In the descriptions below, it is assumed that each of the steps in the control process is performed by the processor of the corresponding one of the edge device 1 and the edge server 2. In other words, the processor (the CPU 101 or the CPU 201) of each of the edge device 1 and the edge server 2 is configured to perform the corresponding steps in the control process.

First, the user attribute acquisition unit 1001 of the edge device 1 acquires the user attribute of the user who operates the edge device 1 by cooperating with the card reader 109 of the edge device 1 (step S101). Next, the OCR processing unit 1002 of the edge device 1 receives, via the operating unit 107, an instruction to execute an OCR process from the user who operates the edge device 1 and acquires an image of a document using the reading unit 108. Then, the OCR processing unit 1002 executes an OCR process on the acquired image to extract text from the image (step S102).

Then, the OCR processing unit 1002 generates a PDF file based on the extracted text (step S103). Next, the transmission and reception unit 1003 of the edge device 1 transmits the user attribute acquired by the user attribute acquisition unit 1001 and the PDF file generated by the OCR processing unit 1002 to the edge server 2 (step S104).

The reception processing unit 2001 of the edge server 2 receives (or acquires) the user attribute and the PDF file from the edge device 1 (step S105). In other words, the processor of the edge server 2 controls the communication unit 205 (or a communication interface) to receive the user attribute and the PDF file (or text data) from the edge device 1. When the reception processing unit 2001 receives (or acquires) the PDF file and the user attribute, the text extraction unit 2002 extracts text from the PDF file (step S106).

Next, the read processing unit 2003 of the edge server 2 refers to the reference DB 2042 and identifies a classification code corresponding to the user attribute received (or acquired) by the reception processing unit 2001. Then, the read processing unit 2003 reads, from the reference DB 2042, DB information that corresponds to the identified classification code and has a similarity level greater than or equal to a predetermined threshold with respect to a term included in the extracted text or the usage of the term (step S107).

Next, the prompt generation unit 2004 of the edge server 2 generates a prompt including an instruction instructing the correction of the extracted text based on the DB information read from the reference DB 2042 by the read processing unit 2003 (step S108).

Next, the text acquisition processing unit 2005 of the edge server 2 inputs the extracted text and the prompt generated by the prompt generation unit 2004 to the proofreading LLM 2043, which corrects the extracted text according to the instruction in the prompt to generate corrected text (step S109). Then, the text acquisition processing unit 2005 acquires the corrected text generated by the proofreading LLM 2043 (step S110).

The text conversion processing unit 2006 of the edge server 2 converts the corrected text acquired by the text acquisition processing unit 2005 into a PDF file (step S111). Next, the output processing unit 2007 of the edge server 2 determines an output destination according to the user attribute and outputs (or stores) the PDF file to the determined output destination (the PDF file storage unit 2044 in the present embodiment) (step S112). Then, the output processing unit 2007 transmits a storage completion notification to the edge device 1 (step S113).

Upon receiving the storage completion notification from the edge server 2, the transmission and reception unit 1003 instructs the display control unit 1004 to display a message indicating the completion of the storage of the PDF file on the display unit 106 of the edge device 1 (step S114).

As described above, in the information processing system S of the present embodiment, the edge device 1 transmits a user attribute and a PDF file to the edge server 2. Then, the edge server 2 generates a prompt including an instruction instructing the correction of extracted text based on DB information that corresponds to the user attribute and read from the reference DB 2042. The edge server 2 inputs the prompt to the proofreading LLM 2043 and acquires corrected text generated by the proofreading LLM 2043. Then, the edge server 2 outputs the acquired corrected text to the output destination corresponding to the user attribute.

Thus, in the information processing system S of the present embodiment, it is possible to acquire corrected text obtained by correcting text extracted by an OCR process in accordance with the user attribute of the user who operates the edge device 1. Furthermore, in the information processing system S of the present embodiment, the output (or storage) destination of the PDF file including the corrected text can be changed according to the user attribute of the user who operates the edge device 1. That is, the information processing system S can correct text according to a user attribute and thereby improve the convenience of the user.

The above-described embodiment can be modified as appropriate by changing parts of the configuration or functions of each of the above-described apparatuses (the edge device 1 and the edge server 2). Therefore, variations of the above-described embodiment will be described below as other embodiments. Note that differences from the above-described embodiment will be mainly described below, and detailed descriptions of the same features as those described above will be omitted. Also, variations described below may be implemented individually or in combination as appropriate.

### (First Variation)

In the above-described embodiment, the user attribute acquisition unit 1001 of the edge device 1 cooperates with the card reader 109 to acquire a user attribute. However, the present disclosure is not limited to this example. As other examples, the user attribute may be acquired by an imaging unit (not shown) by capturing the image of a medium, such as an employee ID card, including information for identifying an individual, may be input via the operating unit 107 by a user operating the edge device 1, and may be read from text extracted by an OCR process.

### (Second Variation)

In the above-described embodiment, the edge server 2 outputs a PDF file to the PDF file storage unit 2044 in accordance with the user attribute. However, the present disclosure is not limited to this example. As another example, the output destination of the PDF file may be specified by inputting the output destination from the operating unit 107 of the edge device 1. In this case, the transmission and reception unit 1003 of the edge device 1 transmits, to the edge server 2, the specified output destination together with the user attribute and the PDF file. Also, in this case, the output processing unit 2007 of the edge server 2 outputs the PDF file including the corrected text to the specified output destination. Furthermore, the edge server 2 may transmit the PDF file including the corrected text to an external server, such as a cloud server (not shown).

### (Third Variation)

In the above-described embodiment, the edge server 2 stores a PDF file in the PDF file storage unit 2044 in accordance with the user attribute and then transmits the storage completion notification to the edge device 1. Alternatively, when the PDF file is stored in the PDF file storage unit 2044 in accordance with the user attribute, the output processing unit 2007 of the edge server 2 may acquire a URL link (hereinafter also referred to as a link) of the stored PDF file and transmit the acquired link to the edge device 1 together with the storage completion notification. When receiving the link and the storage completion notification from the edge server 2, the transmission and reception unit 1003 of the edge device 1 may instruct the display control unit 1004 to display the link and a storage completion message on the display unit 106.

### (Fourth Variation)

In the above-described embodiment, the OCR processing unit 1002 of the edge device 1 generates a PDF file based on extracted text and transmits the PDF file to the edge server 2. However, the present disclosure is not limited to this example. As another example, the extracted text may be transmitted to the edge server 2. In this case, the transmission and reception unit 1003 of the edge device 1 transmits text data of text extracted by the OCR processing unit 1002 and the user attribute to the edge server 2, and the text extraction unit 2002 of the edge server 2 extracts the text from the text data transmitted from the edge device 1.

When the present variation is adopted, step S103 and step S105 described above may be skipped. Also, a document file with a general-purpose file format may be generated based on the text extracted by the text extraction unit 2002 of the edge server 2.

### (Fifth Variation)

In the above-described embodiment, the text conversion processing unit 2006 of the edge server 2 converts the corrected text acquired by the text acquisition processing unit 2005 into a PDF file, and the output processing unit 2007 stores the PDF file including the corrected text in the PDF file storage unit 2044. However, the present disclosure is not limited to this example. Alternatively, the output processing unit 2007 may transmit the corrected text (or text data) to the edge device 1 together with the storage completion notification.

### (Sixth Variation)

In the above-described embodiment, the edge server 2 is installed in an office or the like. However, the present disclosure is not limited to this example, and the edge server 2 may be a cloud server.

### (Seventh Variation)

In the above-described embodiment, a language rule is explanatory text including a term and the usage of the term (that is, a term and a description in the reference DB 2042). However, the language rule is not limited to this example and may include writing rules, such as a style of writing and a grammatical rule. This makes it possible to correct the style of the entire document according to the user attribute and thereby improve the convenience of the user.

### (Eighth Variation)

In the above-described embodiment, the read processing unit 2003 of the edge server 2 identifies a classification code corresponding to the user attribute received (or acquired) by the reception processing unit 2001 of the edge server 2. However, the present disclosure is not limited to this example.

In another example, the user-attribute acquisition unit 1001 of the edge device 1 acquires a user ID uniquely identifying the user and transmits the user ID to the edge server 2. When the user ID is received (or acquired), the reception processing unit 2001 refers to a table (not shown), which is stored in the memory unit 204 of the edge server 2 and associates user IDs with user attributes, and thereby identifies a user attribute corresponding to the received (or acquired) user ID. The read processing unit 2003 identifies a classification code corresponding to the user attribute identified by the reception processing unit 2001.

### (Ninth Variation)

In the above-described embodiment, a PDF file generated based on text extracted by the OCR processing unit 1002 of the edge device 1 is transmitted to the edge server 2. However, the present disclosure is not limited to this example, and text data (a PDF file or the like) generated in advance may be transmitted to the edge server 2.

For example, the edge device 1 may transmit a document (or text data) created by the user to the edge server 2. In this case, the text extraction unit 2002 of the edge server 2 may extract text from the document (or text data) received (or acquired) by the reception processing unit 2001.

Programs executed in the information processing system S according to the present embodiment and variations may be stored in a computer connected to a network, such as the Internet, and may be downloaded via the network. Also, programs executed in the information processing system S of the present embodiment and variations may be provided or distributed via a network, such as the Internet.

Programs executed by the apparatuses (the edge device 1 and the edge server 2) of the above-described embodiment may be provided in advance in a ROM, a storage unit, or the like of each of the apparatuses. The programs executed by the apparatuses of the above-described embodiment may be provided in a non-transitory computer-readable storage medium, such as a CD-ROM, a flexible disk (FD), a CD-R, or a Digital Versatile Disk (DVD) in an installable format or an executable format.

Also, programs executed by the apparatuses of the above-described embodiment may be stored in a computer connected to a network, such as the Internet, and may be downloaded via the network. Furthermore, programs executed by the apparatuses of the above-described embodiment may be provided or distributed via a network, such as the Internet.

While certain embodiments have been described, these embodiments have been presented by way of example only and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A document file management apparatus comprising:
a communication interface;
a storage device that stores reference data containing language rules associated with user attributes; and
a processor configured to:
control the communication interface to receive, from a terminal device, a document file including text data and a user attribute of a user of the terminal device,
read a language rule corresponding to the received user attribute from the reference data,
generate a query including an instruction to correct text included in the text data based on the read language rule,
input the text data and the generated query to a computer model, which generates in response thereto corrected text according to the instruction in the query, and
output and store the corrected text in the storage device as a new document file.

2. The document file management apparatus according to claim 1, wherein
each of the language rules in the reference data includes a term and a description of a usage of the term, and
the processor is configured to read the language rule that is among language rules in the reference data corresponding to the received user attribute and has a similarity level greater than or equal to a threshold with respect to a term or a usage of the term included in the text data.

3. The document file management apparatus according to claim 2, wherein
the processor is configured to calculate the similarity level based on a word-level concordance rate between the text data and the language rules corresponding to the received user attribute.

4. The document file management apparatus according to claim 2, wherein
the reference data further includes classification codes, each of which is associated with one or more user attributes and one or more language rules, and
the processor is configured to:
identify a classification code that is among the classification codes and associated with the received user attribute,
identify language rules in the reference data that are associated with the identified classification code, and
read the language rule that is among the identified language rules and has the similarity level greater than or equal to the threshold.

5. The document file management apparatus according to claim 1, wherein
the processor is configured to determine an output destination of the corrected text based on the received user attribute and output the corrected text to the determined output destination.

6. The document file management apparatus according to claim 5, wherein
the storage device includes a file storage area that is divided into multiple storage areas corresponding to the user attributes, and
the processor is configured to store the corrected text in one of the storage areas that corresponds to the received user attribute.

7. The document file management apparatus according to claim 6, wherein
the processor is configured to control the communication interface to transmit a storage completion notification to the terminal device after storing the corrected text in the one of the storage areas.

8. The document file management apparatus according to claim 7, wherein
the processor is configured to acquire a uniform resource locator link of the corrected text stored in the one of the storage areas and transmit the uniform resource locator link to the terminal device together with the storage completion notification.

9. The document file management apparatus according to claim 1, wherein
the processor is configured to convert the corrected text into a general-purpose file format and output the converted corrected text.

10. The document file management apparatus according to claim 1, wherein
the computer model is a Large Language Model.

11. A method performed by a document file management apparatus, the method comprising:
receiving, from a terminal device, a document file including text data and a user attribute of a user of the terminal device;
reading a language rule corresponding to the received user attribute from reference data containing language rules associated with user attributes;
generating a query including an instruction to correct text included in the text data based on the read language rule;
inputting the text data and the generated query to computer model, which generates in response thereto corrected text according to the instruction in the query; and
outputting and storing the corrected text as a new document file.

12. The method according to claim 11, wherein
each of the language rules in the reference data includes a term and a description of a usage of the term, and
the language rule, which has a similarity level greater than or equal to a threshold with respect to a term or a usage of the term included in the text data, is read from among language rules in the reference data corresponding to the received user attribute.

13. The method according to claim 12, further comprising:
calculating the similarity level based on a word-level concordance rate between the text data and the language rules corresponding to the received user attribute.

14. The method according to claim 12, wherein
the reference data further includes classification codes each of which is associated with one or more user attributes and one or more language rules, and
the method further comprises:
identifying a classification code that is among the classification codes and associated with the received user attribute, and
identifying language rules in the reference data that are associated with the identified classification code, wherein
the language rule having the similarity level greater than or equal to the threshold is read from among the identified language rules.

15. The method according to claim 11, further comprising:
determining an output destination of the corrected text based on the received user attribute, wherein
the corrected text is output to the determined output destination.

16. The method according to claim 15, wherein
the document file management apparatus includes a storage device including a file storage area that is divided into multiple storage areas corresponding to the user attributes, and
the corrected text is stored in one of the storage areas that corresponds to the received user attribute.

17. The method according to claim 16, further comprising:
transmitting a storage completion notification to the terminal device after storing the corrected text in the one of the storage areas.

18. The method according to claim 17, further comprising:
acquiring a uniform resource locator link of the corrected text stored in the one of the storage areas; and
transmitting the uniform resource locator link to the terminal device together with the storage completion notification.

19. The method according to claim 11, further comprising:
converting the corrected text into a general-purpose file format, and
outputting the converted corrected text.

20. A non-transitory computer readable storage medium storing a program for causing a processor of a document file management apparatus to perform a process including:
receiving, from a terminal device, a document file including text data and a user attribute of a user of the terminal device;
reading a language rule corresponding to the received user attribute from reference data containing language rules associated with user attributes;
generating a query including an instruction to correct text included in the text data based on the read language rule;
inputting the text data and the generated query to computer model, which generates in response thereto corrected text according to the instruction in the query; and
outputting and storing the corrected text as a new document file.
